(19) United States
(12) Patent Application Publication
(10) Pub. No.: US 2021/0032763 A1
(43) Pub. Date: Feb. 4, 2021

(54) SYSTEM FOR PROCESS INTENSIFICATION OF WATER ELECTROLYSIS

(71) Applicant: UNIVERSITÉ CATHOLIQUE DE LOUVAIN, Louvain-la-Neuve (BE)

(72) Inventors: Joris PROOST, Kessel-Lo (BE); Quentin DE RADIGUÈS DE CHENNEVIÈRES, Anderlecht (BE); Grégoire THUNIS, Ixelles (BE)

(73) Assignee: UNIVERSITÉ CATHOLIQUE DE LOUVAIN, Louvain-la-Neuve (BE)

(21) Appl. No.: 16/975,497

(22) PCT Filed: Mar. 8, 2019
(86) PCT No.: PCT/EP2019/055883

§ 371 Date: Aug. 25, 2020

(30) Foreign Application Priority Data
Mar. 9, 2018 (EP) 18161044.5

(51) Int. Cl. C25B 1/04; C25B 9/20; C25B 11/03

(52) U.S. Cl. CPC C25B 1/04; C25B 11/035; C25B 9/20

(57) ABSTRACT

A system for water electrolysis, for production of hydrogen and oxygen, including: at least one unit cell having at least two compartments, each compartment being configured to have an electrolyte solution flowing through the compartment, from at least one inlet port to at least one outlet port of the system, at least two being gas-producing porous electrodes, which are at least one anode and at least one cathode, located each in one compartment; at least one electrode being tridimensional; at least one hydraulic circuit, an element for ensuring a forced electrolytic solution flow in each compartment, and an element for applying a DC bias voltage to the electrodes.

### FIELD OF INVENTION

This invention pertains to the field of water electrolysis. In particular, this invention addresses the issue of process intensification in water electrolysis. More specifically, this invention relates to a method for process intensification of water electrolysis and to a device implementing the method.

### BACKGROUND OF INVENTION

Renewable energies such as solar and wind are by nature intermittent. To increase their use, the produced electricity needs to be stored e.g. under the form of hydrogen.

One of the challenges of our societies is therefore to be capable of storing energy in an efficient way. Water electrolysis is known for long as being a way of storing energy. The scientific community agrees on the fact that water electrolysis may be a good solution, but that productivity still needs to be improved. In order to be industrially relevant and competitive, the electrochemical process used for hydrogen production needs to be intensified, i.e. increased production rate and/or decreased unit size. Water electrolysis also needs to be scaled-up to match the size of the most recent wind turbines.

There are numerous searches on the subject. For example, European patent EP2389460 suggest an interesting solution, but produces a mixture of gas, and may have a shelf life limited due to the need of vibrating the electrode to remove the gas bubbles. Moreover, U.S. Pat. No. 5,879,522 discloses an electrolysis cell which uses fluidized bed electrodes comprised in chambers having inlets and outlets for flowing electrolyte. The system of U.S. Pat. No. 5,879,522 uses a source of DC electrical current operatively connected to the electrodes. Another example of electrolysis cell is disclosed by US 2008/220278. The electrochemical system of this patent application comprises a porous electrode and a plurality of suspended nanoparticles diffused within the void volume of the electrode when used within an electrolyte. When in use, reactants may flux though the electrochemical system and gasses generated from reaction may leave the upper face of the porous electrode via gravitational force.

This invention proposes a solution to the prior art backwards, with a robust system able to produce both pure hydrogen and pure oxygen, separately, with an increased productivity over the prior art. Especially, this invention proposes an increase of the useful electrode surface.

### DESCRIPTION

The present invention relates to a system for water electrolysis, for production of hydrogen and oxygen, comprising:
at least one unit cell having at least two compartments, each compartment being configured to have an electrolyte solution flowing through the compartment (3), from at least one inlet port to at least one outlet port of the system;
at least two gas-producing porous electrodes, which are at least one anode and at least one cathode, located each in one compartment, where at least one electrode is tridimensional;
at least one hydraulic circuit;
means for ensuring a forced electrolytic solution flow in each compartment; and
means for applying a DC bias voltage to said electrodes.

According to one embodiment, the unit cell comprises at least one membrane or diaphragm defining the at least two compartments of the unit cell.

According to one embodiment, the means for applying a DC bias voltage comprises an electrical generator connected to at least one electrode to provide a DC bias voltage to the electrodes.

According to one embodiment, the DC bias voltage is applied in pulses of predefined duration with a predefined frequency.

Advantageously, the combination of the application a pulsed DC bias voltage to tridimensional electrodes in a forced electrolytic solution flow greatly improves the electrolysis efficiency.

According to one embodiment, the system comprises a series of unit cells in the form of a filter press cell.

According to one embodiment, said porous electrodes are metal foams electrodes, preferably nickel foam electrodes or nickel alloy foam electrodes.

According to one embodiment, the porous electrodes have a pore size ranging from 1 μm to 3000 μm, preferably 400 to 2500 μm.

According to one embodiment, the porous electrodes have a porosity ranging from 50 to 98% v/v.

According to one embodiment, the linear flow velocity, defined as the ratio of volumetric flow rate to the electrode cross sectional area, ranges from more than 0 to 1.8 10⁻¹ m/s, or to 2 10⁻¹ m/s or preferably from more than 0 to 4 10⁻² m/s.

According to one embodiment, the means for ensuring a forced electrolytic solution flow include an independent tank and a flow generator for the anolyte and an independent tank and a flow generator for the catholyte.

According to one embodiment, the flow generator is a pump.

According to one embodiment, the flow generator ensures a forced flow of the electrolytic solution through the tridimensional porous electrodes.

According to one embodiment, the electrical field generated in the electrolytic solution is perpendicular to the electrode.

This invention thus relates to a system for water electrolysis, especially alkaline water electrolysis, for production of both hydrogen and oxygen, separately, comprising:
at least one unit cell comprising: at least one unit cell having at least two compartments, each compartment being configured to have an electrolyte solution flowing through the compartment, from at least one inlet port to at least one outlet port of the system;
at least two gas-producing electrodes, at least one anode and at least one cathode located each in one compartment of the system; at least one electrode being a tridimensional porous electrode;
at least one hydraulic circuit configured to receive an electrolytic solution;
means for ensuring a forced electrolytic solution flow in each compartment; and
means for applying a DC bias voltage to the electrodes.

In one embodiment, the unit cell comprises at least one membrane or at least one diaphragm. In one embodiment, the membrane is an ion exchange membrane, i.e. the membrane is permeable to cations or to anions. In one embodiment, the membrane is not permeable to water.

In one embodiment, the membrane is polymer membrane. In one embodiment, the membrane is selected for its low electrical resistance, good selectivity and good mechanic stability in both acid and basic environment.

In one embodiment, at least one porous electrode is a tridimensional foam of electroactive material, preferably a metal foam. In one embodiment, the porous electrode is a nickel porous electrode or a nickel alloy porous electrode. In one embodiment, the electrode is a one-piece electrode. In one embodiment, the porous electrode is not made of layers. In one embodiment, the porous electrode is not a conductive base material covered by a catalytic layer. In one embodiment, both the anode and the cathode are porous tridimensional electrodes. In one embodiment, both the anode and the cathode have the same porosity. In one embodiment, the cathode and the anode have different porosities. In one embodiment, the porosity of each electrode, independently, ranges from 50 to 98%, preferably from 80 to 98% v/v, i.e. in volume, with reference to the total volume of the electrode. In one embodiment, the porosity of each electrode, independently, is about 95%. In one embodiment, the length of the tridimensional electrode ranges from 0.1 to 100 mm, preferably from 1 to 50 mm In one embodiment, the width of the tridimensional electrode ranges from 0.1 to 100 mm, preferably from 1 to 50 mm In one embodiment, the thickness of the tridimensional electrode ranges from 0.1 to 100 mm, preferably from 1 to 50 mm In one embodiment, the mean pore size ranges from 100 to 3000 μm, preferably 400 to 2500 μm. In one embodiment, one and/or the other electrode contact the membrane or the diaphragm: an electrode in contact with the membrane (or the diaphragm) is usually referred to as “zero-gap electrode”.

In one embodiment, the electrolyte solution is an aqueous solution where an electrolyte is dissolved in an amount such that the resulting solution is an electrically conductive solution. In one embodiment, the electrolyte solution is an alkaline solution. In one embodiment, the electrolyte is a potassium, sodium, calcium, chloride, hydrogen phosphate or hydrogen carbonate. In one embodiment, the electrolyte solution is a solution having a concentration of 30% KOH, in volume to the volume of the solution. In one embodiment, the electrolyte solution is KOH, 1 to 6 M. Anyway, it is emphazised that electrolyte may be pure water, an acid or a base and in the two latter case, the acid or base concentration is easily adaptable by one skilled in the art. In one embodiment, the pH of the electrolyte ranges from 0 to 14. In one embodiment, the pH of the electrolyte ranges from 0 to 2. In one embodiment, the pH of the electrolyte ranges from 12 to 14. Regarding temperatures, it is well-known by the skilled artisan, that the system may be operated from ambient temperature to higher temperatures, typically 25 to 100° C. or 70 to 100° C. Also, the system may be operated under pressure higher than atmospheric pressure, typically 1 to 40 bars.

In one embodiment, the means for ensuring a forced electrolytic solution flow are at least one tank and at least one pump. In one embodiment, the means for ensuring a forced electrolytic solution flow are an independent tank and pump for the anolyte and an independent tank and pump for the catholyte. In this embodiment, the cell is a plug-flow reactor, to which tanks and pumps are connected for ensuring the flow when the system is in use.

In one embodiment, the tridimensional electrodes are obtained by 3D printing or additive manufacturing. In one embodiment, the forced flow is configured to carry out the gas produced by the electrode. In one embodiment, the forced flow is configured to prevent any clogging of the pores of the electrode. In one embodiment, the forced flow is upward the electrode. In one embodiment, the forced flow passes through the electrode. In one embodiment, the flows have the same pattern in both compartments. In one embodiment, the flow is of higher debit in the cathode compartment than in the anode compartment. In one embodiment, the flow in the cathode compartment is maximized. In one embodiment, the forced flow ranges from 0 to 7000 Re, preferably 300 to 5000 Re, more preferably 400 to 750 Re, even more preferably about 570 Re, where Re is the Reynolds number.

In one embodiment, each tank is a stirred tank.

In one embodiment, the means for ensuring a forced electrolytic solution flow are pumps related to a stirred tank of electrolyte solution and to the hydraulic circuit of the system, ensuring a flow ranging from 0 to 30 mL/s, preferably 0.8 to 25 mL/s in each compartment. In one embodiment, the forced flow refers to a range of 8 to 25 mL/s.

In one embodiment, the linear flow velocity, defined as the ratio of volumetric flow rate to the electrode cross sectional area, ranges from 0 to 2 10⁻¹ m/s in each compartment.

Alternatively, the flow of the electrolytic solution is not forced and is notably obtained by natural convection.

In one embodiment, the means for applying a DC bias voltage to said electrodes are current feeder delivering a DC bias voltage. The DC bias voltage preserves the polarity of the electrodes. In one embodiment, the applied DC bias voltage generates an electrical field in the region comprised between the cathode and anode so as to generate an electric field sensibly perpendicular to the electrolyte solution flow direction. In one embodiment, the DC bias voltage is applied in successive pulses of predefined duration at a predefined frequency. In one embodiment, the pulses of the DC bias pulsed voltage are high frequency pulses. In one embodiment, the predefined duration of the pulses of the DC bias pulsed voltage ranges from 0.050 to 200 ms, preferably 0.100 to 5 ms, more preferably about 2 ms. The choice of the predefined duration of the pulses is crucial to optimize the efficiency of water electrolysis;

This invention also relates to a method for producing both pure hydrogen and pure oxygen, separated, using the system as described above, which preserves the polarity of the electrodes and thereby results in separating the produced hydrogen and oxygen gases with high gas purity and decreases explosion risks.

### DEFINITIONS

In the present invention, the following terms have the following meanings:
“DC bias voltage” refers to a voltage waveform with a positive (resp. negative) DC bias, such that the polarity of the waveform always remains positive (resp. negative). The voltage waveform can be:
   a voltage waveform consisting of one or more rectangular (“flat topped”) pulses, with equal or different heights (“DC bias pulsed voltage”); or
   a combination of one or more sinusoidal AC voltages added to a DC bias voltage (“DC bias AC voltage”).
“3D porous electrode” refers to an electrode in any tridimensional form, in one or several pieces, having a porous network in its density, thereby creating a large electrolytic surface area.
“Forced flow”: flow forced by suitable means such as for example a pump, as opposed to natural convection where the fluid flows under the influence of difference of density (gas vs liquid or hot vs cold fluid).
“about” preceding a figure means plus or less 10% of the value of said figure.
“Anolyte”: electrolytic solution flowing through the anode compartment.
“Catholyte”: electrolytic solution flowing through the cathode compartment.
“Reynolds (Re) number is a dimensionless group characterizing the flow conditions in a particular reactor geometry: Re=vl/v where v is the mean velocity of the fluid, l the hydraulic diameter of the cell and v the kinematic viscosity. It represents the ratio of inertial forces to viscous forces in a liquid.

### BRIEF DESCRIPTION OF THE DRAWINGS

FIG. 1: general scheme of a system of the invention, comprising a unit cell inserted in a hydraulic circuit and one 3D electrode.

FIG. 2: general scheme of a system of the invention, comprising a unit cell inserted in a hydraulic circuit and two 3D electrodes.

FIG. 3: FIG. 3A: schematic of a filter press cell (2) with a 3D electrode operating in flow-by configuration—FIG. 3B: commercial Micro Flow cell.

FIG. 4: Drawing of the half-cell with the 3D electrode and a reference electrode.

FIG. 5: Photograph showing nickel foams of the various porosities.

FIG. 6: refers to three graphs, FIG. 6A, FIG. 6B and FIG. 6C showing comparative effect of a DC bias pulsed voltage on the electrolysis of water. FIG. 6A: comparison of the resulting current, at 1.9 V for various flow rates in a system having 2D electrodes only (no 3D electrodes). FIG. 6B: Comparison of the resulting current, at 1.9 V for various flow rates in a system having 3D electrodes (pore size: 450 μm). FIG. 6C: Comparison of the resulting current, at 1.9 V for various flow rates in a system having 3D electrodes (pore size: 580 μm).

FIG. 7 refers to three graphs, FIG. 7A, FIG. 7B and FIG. 7C showing the effect on the electrolysis of water of different pulses durations for the pulsed DC bias voltage. FIG. 7A compares the resulting currents obtained with a system having a simple 2D electrodes, at 1.9 V for various flow rates (NC=natural convection, i.e. no forced flow). FIG. 7B compares the resulting currents obtained with a system having 3D electrodes (pore size: 450 μm), at 1.9 V for various flow rates. FIG. 7C compares the resulting currents obtained with in a system having 3D electrodes (pore size: 580 μm), at 1.9 V for various flow rates.

### DETAILED DESCRIPTION

The following detailed description will be better understood when read in conjunction with the drawings. For the purpose of illustrating, the system is shown in the preferred embodiments. It should be understood, however that the application is not limited to the drawings precise arrangements, structures, features, embodiments, and aspect shown. The figures are not drawn to scale and are not intended to limit the scope of the claims to the embodiments depicted. Accordingly, it should be understood that where features mentioned in the appended claims are followed by reference signs, such signs are included solely for the purpose of enhancing the intelligibility of the claims and are in no way limiting on the scope of the claims

In one embodiment, the filter press set-up used for the water electrolysis on foam electrodes is presented. First the filter press, where the 3D electrode is in flow-by mode will be shown as well as the hydraulic circuit where this cell is in batch recycle mode. Then the experimental procedure for the water electrolysis study will be detailed.

Hydraulic Circuit

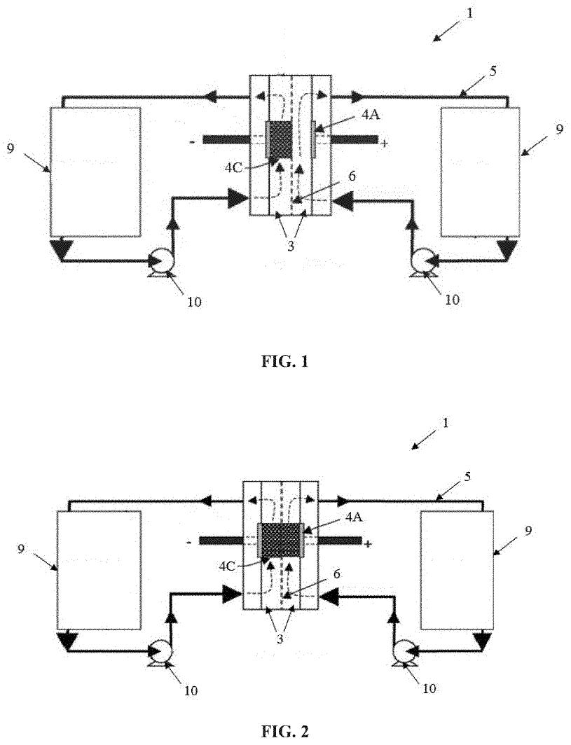

The electrochemical cell was inserted into a hydraulic circuit 5, shown schematically in FIG. 1 and FIG. 2. It comprises two pumps 10 forcing the circulation of the electrolyte in each compartment 3 of the filter press cell. The electrolyte solution then flows back into a 1 L stirred tank 9. The membrane of the cell allows separating the electrolytes in the cell. An independent tank 9 and pump 10 was used for the anolyte and the catholyte. Therefore, the filter press cell can be considered to work as plug-flow reactor with perfectly stirred tanks 9. Before each experiment, the hydraulic circuit 5 is tested for water leaks by circulating the solutions through the cell. When possible, the flow rate of the pumps 10 was measured before each experiment by a volumetric method. Measurements of the flow rate after the electrorecovery experiments show no change in the flow rate after metal deposit. This method consists of measuring the time necessary to fill a fixed volume, i.e. 500 mL with the solution flowing through the cell. Working with nitrogen purged solutions, the volumetric method would inject oxygen in the solution between each experiment. It is therefore necessary to calibrate the flow rate with the scale of the pump 10 as it is not possible to measure the flow rate before each experiment. This technique however is less accurate than measuring the flow rate before each experiment. The pumping rate was adjusted in order to obtain an electrolyte flow varying from 0 to 30 mL/s, preferably 0.8 to 25 mL/s in each compartment 3. The corresponding mean linear flow velocities v, defined as the ratio of volumetric flow rate to the electrode cross sectional area, therefore varied from 0 to 2 10⁻¹ m/s or 0 to 1.8 10⁻¹ m/s in both compartments 3. As the void fraction of the used porous materials is very high, the linear velocity in the pore is essentially the same as calculated for an empty cathode compartment 3.

Electrochemical Cell

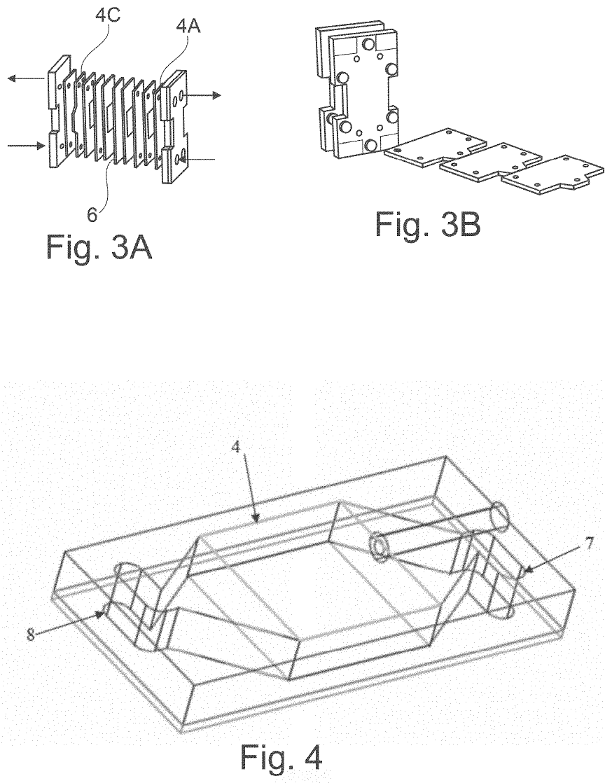

Experiments were performed in a commercial electrochemical filter press cell (Micro Flow cell from Electrocell), shown schematically in FIG. 3A. The cell contains a stainless steel cathode current feeder 4C, an anode 4A, two PTFE holders, 6 rubber joints, a membrane 6 and two side plates. A picture of the commercial cell is shown on FIG. 3B. The anodic and cathodic compartments 3 were separated by a polymer membrane 6. The 3D electrode 4 is a piece of porous conducting material such as nickel foam placed in a PTFE holder maintaining it in the center of the cathodic compartment 3. This PTFE holder also impeaches lateral by-pass of the electrolytic solution. The same PTFE holder was also used in the anodic compartment 3. Electrical contact between the feeder and the porous tridimensional cathode was made by pressing the cell together. This way, any glue manipulation is avoided and no solvents contaminate the solution. The cell was closed by 6 screws holding the side plates. The electrical contact made by these collectors generated a current flow perpendicular to the electrolyte solution flow (flow-by configuration). The membrane permeable to cations but not to water forces the electrolytic solution to pass through the porous electrode 4. An upstream flow was imposed to avoid gaseous accumulation in the electrode compartments 3. FIG. 4 shows a half-cell with an inlet port 7, an outlet port 8, the 3D electrode 4, the reference electrode and the PTFE separators.

Porous Electrodes

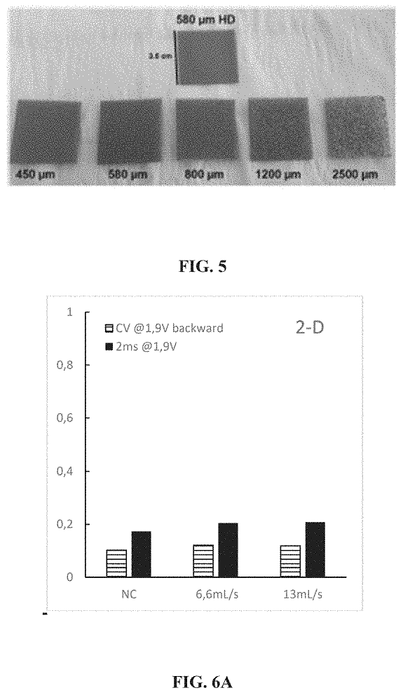

The three-dimensional electrodes 4, were both 35 mm×35 mm×6 mm in volume (Ve). Pure nickel foams were used. FIG. 5 shows a picture of 3D nickel foams used. Table 1 summarizes the main properties of the used RVC foams: the mean pore size dₚ mean in pm, the porosity in %, the sheet thickness D in mm and the specific surface area Ae in m²/dm³. Nickel was chosen as industrial electrolyzers typically use nickel electrodes.

TABLE 1
Properties of Ni foams

| | c | D | Aₑ |
|---|---|---|---|
| dₚ mean μm | % | mm | m²/dm³ |
| 450 | 85 | 1.6 | 7.8 |
| 580 | 90 | 1.9 | 6.9 |
| 580 HD | . . . | 1.9 | 10 |
| 800 | 90 | 2.5 | 6 |
| 1200 | 90 | 3 | 4.3 |
| 2500 | 94 | 4.5 | 1.5 |

Nickel has a high exchange current density for the hydrogen reaction and it is relatively cheap compared to other metals with comparable or high exchange current density. It is also resistant to corrosion and will not dissolve when used as an electrode 4.

Exchange Membrane

A Fumasep FAA-3-PK-130 membrane commercialized by Fumatech was used.

Power Source

The current and potential were controlled and measured using an Autolab PGSTAT302N or an Ametek Modulab XM potentiostat. Both are computer controlled with a software. The working electrode (WE) connector of the potentiostat is connected to the nickel current feeder of the anode. The counter electrode (CE) connector of the potentiostat is connected to the cathode. During linear sweep experiments, a varying potential is imposed between the cathode and anode. The potential between the anode and the cathode was varied between 1.22 V and 3 V. This way, the potential was swept from the equilibrium potential of water electrolysis till the potential where the current was found to saturate.

Gas Collection and Airtight Catholyte Tank

To study the gas production during water electrolysis, a system to collect and measure the volume of produced gases was added. An airtight tank 9 was used for this. The electrolyte solution outlet has been placed at the bottom of the tank 9 to minimize the recirculation of gas bubbles modifying the liquid flow in the cell. The electrolyte solution inlet has been placed at the opposite side of the outlet to avoid bypass of the liquid in the tank 9. At the top, a gas outlet is provided to collect the produced hydrogen. Nitrogen can be bubbled in the tank to deaerate the solution to purge the dissolved oxygen in the solution as it can interfere with the water reduction at the cathode.

Ultra-Pure Water

Ultra-pure water was used to prepare the solutions and rinse the experimental set-up Ultra-pure water is produced by an Arium 611 DI system commercialized by Sartorius Stedim Biotech1. The ultra-pure water has a resistivity of about 18 MΩ cm and a TOC (Total Organic Carbon) lower than 4 ppb.

Electrolytic Solutions

Two solutions are prepared in two 1 L flasks with ultra pure water. They contain 1 M KOH serving as supporting electrolyte solution.

Conclusion

The use of the 3D cathode shows a significant increase in H₂ production (×1.5), with comparison of the mere use of a 2D electrode. Without willing to be linked by any theory, the Applicant suggest that the gain of productivity may be related to the increase of inner surface for same macroscopic volume; and/or to a better mass transfer.

Experimental Procedures

Cyclovoltammetry Experiments

During the cyclic voltammetry (CV) experiment, the cathode electrode potential was ramped linearly versus time from 1.22 V to 3 V at 0.1 V/s scan rate. When the potential reached 3 V, the ramp was inverted and the potential was decreased until it reached 1.22 V. This cycle was repeated 3 times. The catholyte was deaerated with nitrogen during 10 min to remove the dissolved oxygen before each CV experiment. To avoid the influence of the uncompensated resistance, linear sweep voltammetry (LSV) were performed using the potentiostat. These experiments were similar to the CVs excepted that the potential is ramped completely linearly instead of stepwise as in the CVs.

Pulsed Method

In this work, a pulsed method was developed to study the impact of a DC bias pulsed voltage on the efficiency of alkaline water electrolysis. The potential between the two electrodes 4 was ramped up from the start potential (1.2 V) to the stop potential (3 V) in steps. The duration of the steps was kept constant during the experiment (e.g. 20 ms). Between each step, the potential was decreased to the base potential (1.2 V). To take into account this voltage, we made the sum of the mean of the voltage when the potential is applied Ion with the mean of the current when the potential base is applied I_{off}. This way we take the negative current I_{off} into account, coming from H₂ consumption, electrode oxidation, etc.

Combined Effect of 3D Electrodes and DC Bias Pulsed Voltage Effects

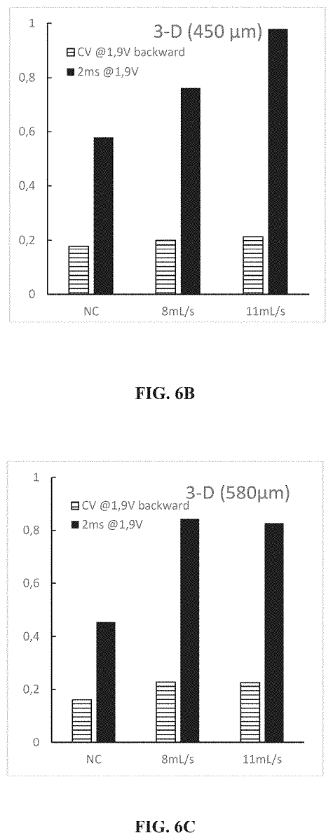

FIGS. 6A, 6B and 6C show the effect of a DC bias pulsed voltage on the electrolysis of water in the system of the invention. The comparison parameter is the current measured at 1.9 V, which is a typical value in the industry for a water electrolysis cell. We see on the left of each couple of histogram the current measured during a conventional CV (non-pulsed current) and on the right of each couple of histogram, the current measured for pulses of 2 ms (the smallest possible value with our material). On each Figure, we have represented currents for 3 flow values: natural convection (NC), low forced flow (7-8 mL/s) and high forced flow (11-13 mL/s). FIG. 6A shows the effect of the pulses for two plane electrodes. The effect of the pulses and the forced flow is little marked. FIG. 6B and FIG. 6C, on the other hand, we see a clear pulse effect, accentuated by forced flow.

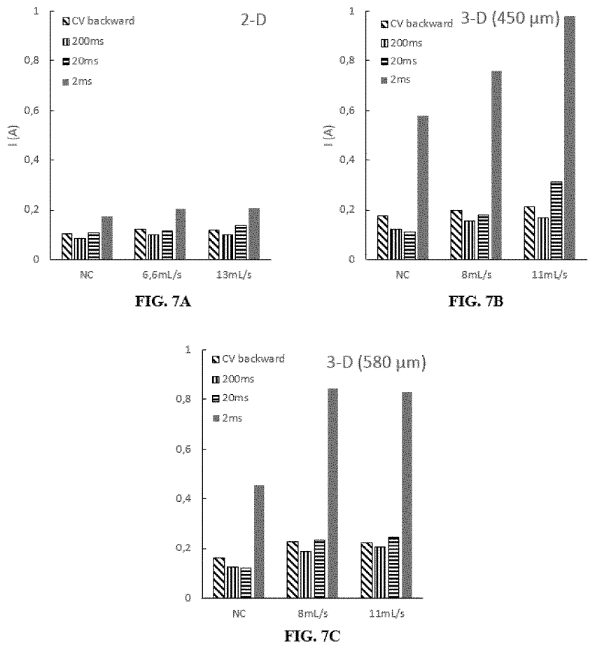

FIGS. 7A, 7B and 7C show the effect of pulse duration of the pulsed DC bias voltage on the electrolysis of water in the system of the invention. As for the preceding experiment, the comparison parameter is the current measured at 1.9 V, which is a typical value in the industry for a water electrolysis cell. These results show that pulses of 200 ms and 20 ms tend to have little or sometimes a negative effect, while 2 ms pulses improve the value of the resulting current. FIG. 7A clearly shows that using 2D electrodes the effect introduced by the forced high flow is barely visible. In other words, the importance of 3D electrodes only becomes obvious in combination with forced flow and DC bias voltage.

These experiments show the joint effect of the 3 technologies: 3D electrodes, forced flow and DC bias pulsed voltage.

### REFERENCES

1 system for water electrolysis, for production of hydrogen and oxygen, according to the invention
3 compartment
4 electrode
4A anode
4C cathode
5 hydraulic circuit
6 membrane or diaphragm
7 inlet port
8 outlet port
9 tank comprising an anolyte or a catholyte
10 pump

1-13. (canceled)

14. A system for water electrolysis, for production of hydrogen and oxygen, comprising:
at least one unit cell having at least two compartments, each compartment being configured to have an electrolyte solution flowing through the compartment, from at least one inlet port to at least one outlet port of the system;
at least two gas-producing porous electrodes, which are at least one anode and at least one cathode, located each in one compartment, where at least one electrode is tridimensional;
at least one hydraulic circuit;
means for ensuring a forced electrolytic solution flow in each compartment; and
means for applying a DC bias voltage to said electrodes.

15. The system according to claim 14, wherein the unit cell comprises at least one membrane or diaphragm defining the at least two compartments.

16. The system according to claim 14, wherein the means for applying a DC bias voltage comprises an electrical generator connected to the at least one electrode to provide a DC bias voltage to said electrode.

17. The system according to claim 14, wherein the DC bias voltage is applied in pulses.

18. The system according to claim 14, comprising a series of unit cells, in the form of a filter press cell.

19. The system according to claim 14, wherein said porous electrodes are metal foams electrodes, preferably nickel foam electrodes or nickel alloy foam electrodes.

20. The system according to claim 14, wherein said porous electrodes have a pore size ranging from 1 μm to 3000 μm, preferably 400 to 2500 μm.

21. The system according to claim 14, wherein said porous electrodes have a porosity ranging from 50 to 98% v/v.

22. The system according to claim 14, wherein the linear flow velocity, defined as the ratio of volumetric flow rate to the electrode cross sectional area, ranges from more than 0 to 1.8 10⁻¹ m/s, or to 2 10⁻¹ m/s or preferably from more than 0 to 4 10⁻² m/s in each compartment.

23. The system according to claim 14, wherein the means for ensuring a forced electrolytic solution flow include an independent tank and a flow generator for the anolyte and an independent tank and a flow generator for the catholyte.

24. The system according to claim 23, wherein the flow generator is a pump.

25. The system according to claim 23, wherein the flow generator ensures a forced flow of the electrolytic solution through the tridimensional porous electrodes.

26. The system according to claim 14, wherein the electrical field generated in the electrolytic solution is perpendicular to the electrode.
